(19) United States
(12) Patent Application Publication
(10) Pub. No.: US 2025/0153557 A1
(43) Pub. Date: May 15, 2025

(54) Compact Axial Flux Electric Motor and Gearbox

(71) Applicant: Conifer Systems, Inc., Middletown, DE (US)

(72) Inventors: Yateendra B Deshpande, Sunnyvale, CA (US); Padmanabhan Kumar, Fremont, CA (US); Brett Hazama Lum, Sunnyvale, CA (US); Harnavpreet Singh Gill, Surrey (CA)

(21) Appl. No.: 18/943,798

(22) Filed: Nov. 11, 2024

Related U.S. Application Data
(60) Provisional application No. 63/598,100, filed on Nov. 11, 2023.

(51) Int. Cl. B60K 7/00; B60K 17/04

(52) U.S. Cl. CPC B60K 7/0007; B60K 17/043; B60K 2007/0092

(57) ABSTRACT

Systems and methods related to compact axial flux electric motor and gearbox are disclosed herein. A drive train for a wheeled vehicle may include a fixed axle, an axial flux electric motor, and a gearbox. The axial flux motor may include a first set of bearings supported on the fixed axle and a rotor shaft supported by the first set of bearings. The gearbox may be supported on the fixed axle by a second set of bearings, and may include a sun gear rigidly connected to a rotor of the axial flux motor as well as a planetary gear in contact with the sun gear. The output of the gearbox may be rigidly connected to a wheel hub and the planetary gear. Due to its compactness, the axial flux machine may be placed closer to the center of gravity of the wheel it drives.

### CROSS REFERENCE TO RELATED APPLICATIONS

This application claims the benefit of U.S. Provisional Patent Application No. 63/598,100, filed Nov. 11, 2023, which is incorporated by reference herein in its entirety for all purposes.

### BACKGROUND

Axial flux electric machines were first patented in U.S. Pat. No. 405,858 by Nikola Tesla in 1889. However, the usage of such machines in commercial space had been largely rare until the invention of the high-performance Neodymium-Iron-Boron (Nd—Fe—B) permanent magnet material in 1983. Since then, axial flux electric machines have gained widespread adoption on rapid scale due to their high efficiency and compact nature as compared to other technologies. The emergence of environmentally friendly technologies like electric vehicles have further boosted the application space of axial flux electric machines. Today, axial flux electric machines are used in electric vehicles, robots of various sizes and types, and electric or hybrid propulsion systems for aircraft. It is generally desirable to reduce the power losses produced in electric machines to thereby improve the machines' energy conversion efficiency. It is also desirable to keep electric machines lightweight and compact and to reduce their upfront manufacturing costs.

Axial flux electric machines typically comprise a stationary assembly and a rotating assembly. In its most basic form, an axial flux electric machine comprises at least three parts: a stator, a rotor, and a rotor shaft. Stators are stationary parts, whereas rotors and rotor shafts are rotating parts. An axial flux electric machine can also include more than one stator or more than one rotor. Two examples of axial flux electric machines are shown in FIG. 1. Axial cross section 100 shows an axial flux electric machine having one rotor and two stators and axial cross section 110 shows an axial flux electric machine having one stator and two rotors. Radial cross section 111 shows a stator in either axial flux electric machine. Radial cross section 112 shows a rotor in either axial flux electric machine. The axial flux electric machine functions by exchanging electric energy and the rotational energy of the rotating parts using a magnetic field that is in the direction of rotation of the rotating parts.

The manner in which electrical energy and rotational momentum are exchanged in an axial flux electric machine depends on the specific design of the machine. With respect to axial flux electric motors, the design can include permanent magnets and controllably magnetized magnets. The permanent magnets can be on the rotor or the stator and the controllably magnetized magnets can be on either the rotor or the stator. Stator 101 and rotor 102 can be the stators and rotors on the two different kinds of illustrated axial flux electric machines as illustrated in FIG. 1. In the provided examples, the permanent magnets are on the rotor while the stator can be controllably magnetized to rotate the rotor. However, in alternative examples, the permanent magnets are on the stator and the rotor can be controllably magnetized.

The controllably magnetized magnets can include conductive coil windings and soft magnetic material. In the axial flux electric machines of FIG. 1, the stator comprises coil windings 105 wherein the coils are made of conductive material, and terminals of the electrically conductive coils are exposed externally to be energized by an external electrical circuit. Typical conductive materials for coils are aluminum and copper. As shown in FIG. 1, a conductive wire is coiled around a trapezoidal shaped pole piece 106 to form coils windings 105. Such pole pieces are manufactured using complicated molding processes using soft magnetic materials and laminations. The soft magnetic material is what allows the device to be configurably magnetized under the influence of current applied to the coiled wire. As shown in axial cross section 100, portions of the axial flux electric machine (e.g., rotor 102, permanent magnets 103, coil windings 105, pole piece 106) may be contained within motor housing 107.

The rotor can be connected to a rotor shaft to transfer the rotational momentum of the rotor to an external system. As illustrated in FIG. 1, a rotor 102 can house a circular array of specifically spaced, alternating pole, permanent magnets 103 and be coupled to rotor shaft 109. The rotor is typically supported by one or more bearings 108 that allow rotation of the rotor about an axis of rotation while maintaining a substantially uniform air-gap between the rotor and stator. In the example of an axial flux motor in accordance with the examples in FIG. 1, when the coils of the stator are energized, the current flowing through the coils generates magnetic fields between two adjacent coils having opposite polarities, which alternate, and the magnetic flux generated by the coils repels or attracts a permanent magnet close to them, inducing torque and rotation of the rotor. The rotor shaft coupled to the rotor, in turn, transfers the torque to an externally connected load.

### SUMMARY

Axial flux electric machines integrated with gear trains and associated methods and systems are disclosed herein. An axial flux electric machine with an integrated gear train may be referred to as a drive train. The axial flux electric machines may be permanent magnet synchronous AC electric machines in the form of axial flux electric machines. The axial flux electric machines may be either motors or generators. The axial flux electric machines and associated gear trains may be designed to be compactly integrated with an electric mobility vehicle or power machinery. In specific embodiments, the axial flux electric machines and associated gear trains may be supported by a through rod or axle such as an axle supporting one or more wheels of an electric mobility vehicle. For example, the axial flux electric machine and associated gear train can be supported by an axle of a rear wheel of an electric scooter.

In specific embodiments, the axial flux electric machines and gear trains disclosed herein can be compactly integrated. For example, the axial flux electric machines and gear trains can be adjacent to each other on an axle that supports the axial flux electric machine and gear trains. The axle can be the axle of a wheel that is driven by the axial flux electric machine and the gear train. As another example, in approaches in which the axial flux electric machine and gear train are supported by the axle of a wheel, the gear train can be at least partially surrounded by the wheel hub. In certain applications, such as when the axial flux electric machine and gear trains are integrated with an electric vehicle, the compact nature of these designs exhibit significant benefits in that the axial flux electric machine is placed closer to the center of gravity of the wheel it drives. Furthermore, if the electric vehicle is a scooter or other vehicle in which the wheel is expected to tilt down towards the ground, the compact axial electric machines and gear train integration designs disclosed herein interfere less with the potential operation of the vehicle because they are so compact.

In specific embodiments of the invention, the problem of how to tightly integrate an axial flux electric motor and gearbox with a wheel located on a fixed support axle is solved by placing an axial flux electric motor next to a gearbox where the output of the gearbox is connected to the wheel hub of the wheel, mechanically coupling a rotor of the electric motor to a sun gear of the gearbox where the sun gear rotates one or more planetary gears that rotate the output of the gearbox, supporting the axial flux electric motor on a first set of bearings on the fixed support axle, and supporting the gearbox on a second set of bearings on the fixed support axle.

The integration of axial flux motors as a prime mover in automotive and other mobility applications is increasingly becoming prevalent. Axial flux motor with hollow shafts can be integrated with a wheel hub and coupled with systems that transmit power to the wheel. The axial flux motor can include permanent magnet rotors mounted on a flanged hollow shaft. This flanged shaft can be hollow to accommodate a through rod or an axle that is conventionally used in applications such as automotive, robotics, power machinery, or micro mobility applications. For example, the axle could be the axle for the wheel of an electric scooter, bike, or two-wheeler motorcycle. The axial flux motor can be coupled with an epicyclic planetary gear train that includes a hole through its center gear (e.g., a sun gear) to accommodate the through axle. As such, both the center of the gear train and motor can accommodate, and can be supported by, the same through axle. A gear train and axial flux electric motor can be compactly placed adjacent to each other on the through axle. The torque from the axial flux motor can be multiplied by the transmission to result in a circular motion of the output member of the system. The output member of the system can be connected to the wheel hub to transmit rotational power which in turn can be used for locomotion or other applications as needed.

In specific embodiments of the invention, a drive train for a wheeled vehicle is provided. The drive train for the wheel vehicle comprises: a fixed axle and an axial flux electric motor, where the axial flux electric motor includes: (i) a first set of bearings supported on the fixed axle and (ii) a rotor shaft supported by the first set of bearings. The drive train further comprises a gearbox supported on the fixed axle by a second set of bearings, where the gearbox includes: (i) a sun gear rigidly connected to a rotor of the axial flux electric motor, and (ii) at least one planetary gear in contact with the sun gear. An output of the gearbox is rigidly connected to a wheel hub and the at least one planetary gear.

In specific embodiments of the invention, a wheeled vehicle is provided. The wheeled vehicle comprises: at least one wheel hub, a fixed axle, and an axial flux electric motor, where the axial flux electric motor includes: (i) a first set of bearings supported on the fixed axle and (ii) a rotor shaft supported by the first set of bearings. The wheeled vehicle further comprises a gearbox supported on the fixed axle by a second set of bearings, where the gearbox includes: (i) a sun gear rigidly connected to a rotor of the axial flux electric motor and (ii) at least one planetary gear in contact with the sun gear. An output of the gearbox is rigidly connected to the at least one wheel hub and the at least one planetary gear.

In specific embodiments, a method is provided. The method comprises rotating a rotor of an axial flux electric motor, where the axial flux electric motor includes: (i) a first set of bearings supported on a fixed axle and (ii) a rotor shaft supported by the first set of bearings. The method further comprises rotating, based on rotating the rotor, a planetary gear of a gearbox, the gearbox being supported on the fixed axle by a second set of bearings, where the gearbox includes a sun gear rigidly connected to the rotor and in contact with the planetary gear. The method further comprises rotating, based on rotating the planetary gear, a wheel hub, the wheel hub being rigidly connected to the planetary gear.

As used herein, a “rigid” connection may allow for some small misalignment. As used herein, the term “rotor” may refer to a rotor or to a rotor disc. In specific embodiments, where multiple “rotors” are connected to (e.g., mounted on) the same rotor shaft (e.g., hollow shaft), this may be interpreted to mean that multiple “rotor discs” are mounted on the same rotor shaft, such that these separate “rotors” form a single rotor. Similarly, the term “stator” may refer to a “stator” or to a “stator disc.” In specific embodiments where different “stators” are electrically connected, each “stator” may refer to a “stator disc” such that each of the “stators” form a single stator.

### BRIEF DESCRIPTION OF THE DRAWINGS

The accompanying drawings illustrate embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates axial flux electric machines in accordance with the related art.

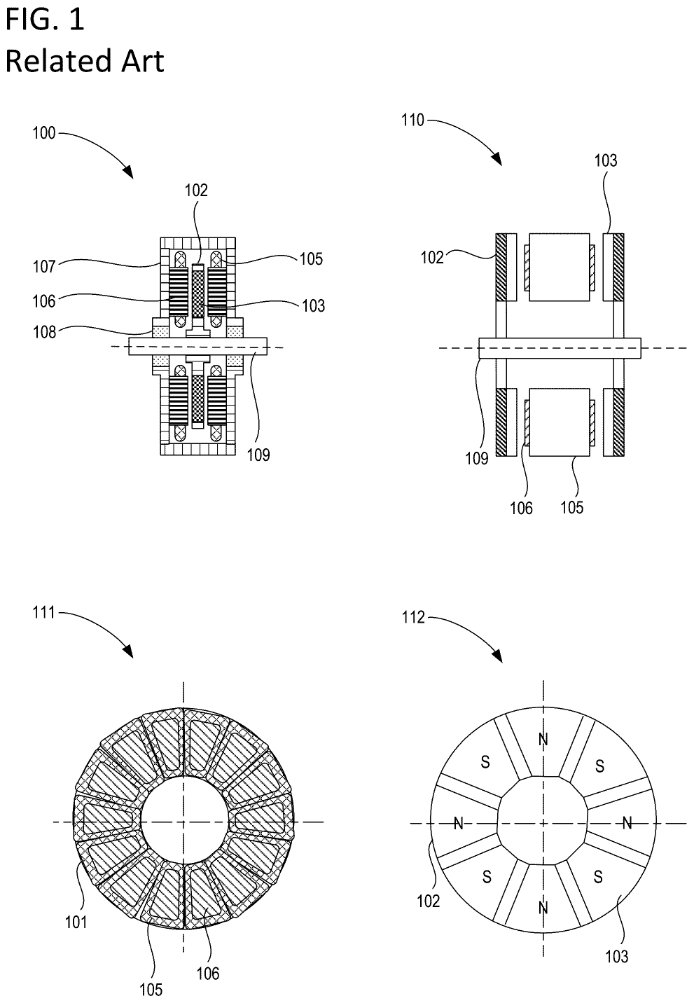

FIG. 2 provides an example of a system with an axial flux motor featuring a fixed axle providing support for the stationary part of the system in accordance with specific embodiments of the inventions disclosed herein.

FIG. 3 provides an example of a system with an axial flux motor featuring a fixed axle providing support for the stationary part of the system, where the system includes a stepped planet gear in accordance with specific embodiments of the inventions disclosed herein.

FIG. 4 provides an example of a system with an axial flux motor featuring a fixed axle providing support for the stationary part of the system, where the system includes two adjacent and co-axial stators and three rotors in accordance with specific embodiments of the inventions disclosed herein.

FIG. 5 provides an example of a system with an axial flux motor, a gear train, spacers, and preload nuts in accordance with specific embodiments of the inventions disclosed herein.

FIG. 6 provides an example of an assembly of the system of FIG. 5, featuring two axial spacing rings and a fastener in accordance with specific embodiments of the inventions disclosed herein.

FIG. 7 provides an example of an assembly of the system of FIG. 5, featuring a pair of tapered roller bearings in accordance with specific embodiments of the inventions disclosed herein.

FIG. 8 provides an example of an assembly of the system of FIG. 5, featuring preload components in accordance with specific embodiments of the inventions disclosed herein.

FIG. 9 provides an example of lubrication of the system of FIG. 5 in accordance with specific embodiments of the inventions disclosed herein.

FIG. 10 provides an example of a planetary system in accordance with specific embodiments of the inventions disclosed herein.

FIG. 11 provides an example of a wheeled vehicle having a drive train in accordance with specific embodiments of the inventions disclosed herein.

FIG. 12 provides an example of a method for operating a compact axial flux electric motor and gearbox in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems related to axial flux electric machines in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In specific embodiments of the invention, an axle within an axial flux electric motor is designed for co-axial integration with the wheel of a vehicle. Traditionally, axial flux electric motors are not equipped to handle a standard axle commonly found in vehicles. Axial flux electric motors perform well in high power-to-torque ratio applications with tight spatial constraints in the axial direction for example in an “in-wheel” drive unit for vehicles. In standard in-wheel drive units, the output of the motor typically consists of a solid shaft that traverses the axis of motion of the axial flux electric motor. These designs often also require the support of a static axle spanning across the prime mover. In contrast, using specific embodiments disclosed herein, the hollow shaft design maintains the structural integrity of the motor and its components while utilizing the same static axle that supports the wheel of the vehicle to support the axial flux electric motor.

In specific embodiments, an axial flux motor includes a hollow shaft which necessitates the modification of internal motor and transmission components, including bearings, shafts, rotor plates, stators, and more. The bearings can be located in the hollow shaft and support the axial flux motor on the axle. The rotor plates can be supported by the bearings and include a hollow center. The stators of the motor can be supported by the axle. In specific embodiments, the stators can be attached to a motor housing which is supported by the axle. In specific embodiments, a gear train may be connected to the axial flux motor. An axial flux motor and gear train assembly may be referred to as a drive train. An axial flux motor may also be referred to as an axial flux electric motor, an axial flux machine, or an axial flux electric machine.

In specific embodiments, the rotors of the axial flux motor are rigidly connected to a gear train to transfer their rotational movement to the gear train. In specific embodiments, the axle can support multiple stators and multiple rotors where each rotor can be rigidly connected to the same gear train. As used herein, a “rigid” connection may allow for some small misalignment. For example, misalignment may occur due to wheel forces acting on axle which may distort the axle by a small distance (e.g., a few hundred micrometers), causing misalignment between so sets of bearings. The gear train can be an epicyclic gear train. The sun gear of the epicyclic gear train, situated at the center of the rotational axis of the gear train, can be designed to incorporate a central hole to accommodate the same axle that supports the axial flux electric motor. This modification ensures the system's stability while enabling the transmission of torque. The planetary carrier, typically serving as the output shaft of an epicyclic gear train, is also adapted to connect to the wheel hub, effectively powering the wheel hub while featuring a through hole for axle support. This approach allows for the simultaneous powering of a wheel hub and the provision of a through hole in both the electric motor and gear train for system support and compact integration with the wheel hub. In specific embodiments, the gear teeth count on the sun, planet, and ring gear are chosen to achieve torque, efficiency, and packaging enhancements, and the number of gear teeth for each may be a prime number.

In specific embodiments, an axial thrust bearing may be used between the sun gear and an axial spacing ring to set the axial gaps. The axial thrust bearing and axial spacing ring may surround the fixed axle. In specific embodiments, a second axial spacing ring is next to the axial spacing ring and a fastener (such as a circlip, nut, ring, screw, bolt, anchor, roll pin, etc.) may be between the two axial spacing rings. This assembly of spacing rings and a fastener may act to restrict sideways motion of the stators and rotors of the axial flux machine such that the relative distance between the stators, rotors, and axial flux machine housing do not change. Accordingly, the airgap may be maintained.

In specific embodiments, a lubricant (e.g., transmission oil, grease) may be input to the drive train. The lubricant may be shared between the gearbox and axial motor sections. The pumping action of a rotor of the axial motor may result in lubricant flow that reaches many or all gears and bearings of the drive train. A gap between the sun gear and the rotor shaft may provide passage for the lubricant to reach high speed rotor bearings. In specific embodiments, a separator plate between the motor housing and gearbox cover may regulate the flow of lubricant.

In specific embodiments, bearings of the drive train may be preloaded. The bearings may be used to support and provide a rigid path for external loads seen by a wheel rim and hub. Two nuts may be tightened on a spacing ring to transmit the preload to the bearings. The first nut may provide the preload to the bearings and the second nut may prevent the loss of preload.

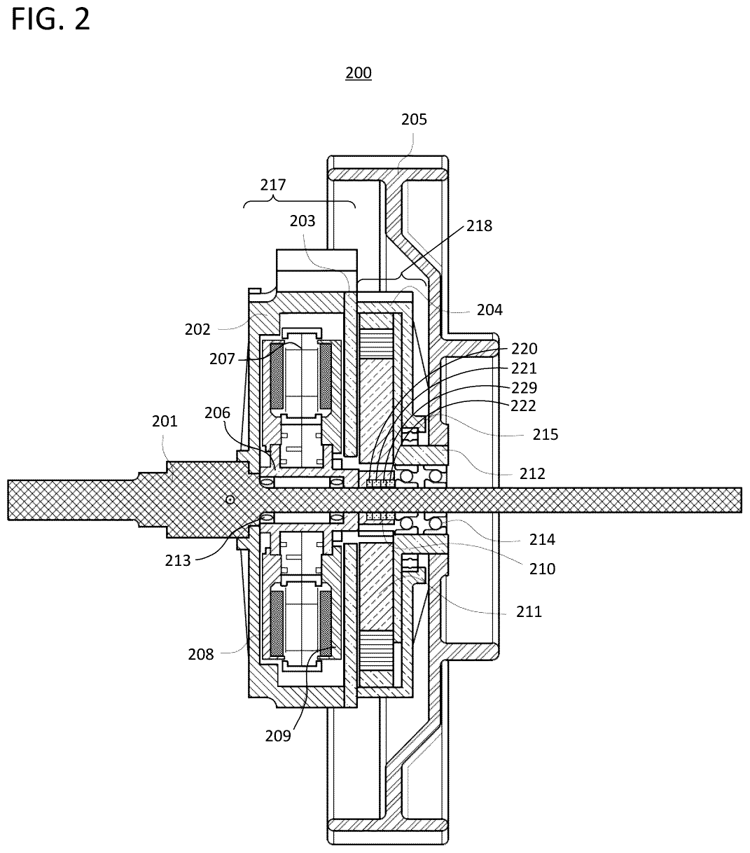

FIG. 2 illustrates axial flux motor 217 featuring fixed axle 201 (e.g., a through shaft), providing support for the stationary part of system 200 in accordance with specific embodiments of the inventions disclosed herein. Fixed axle 201 is mounted on both sides of axial flux motor 217, runs through hollow shaft 206, and is non-rotating. That is, fixed axle 201 goes through axial flux motor 217 and gearbox 218 (e.g., the transmission). Axial flux motor 217 and gearbox 218 may be adjacent on fixed axle 201. Hollow shaft 206 may also be referred to as a rotor shaft. In specific embodiments, the incorporation of hollow shaft 206 into system 200 necessitates the modification of internal motor and transmission components, (e.g., bearings, shafts, rotor plates, stators, and more) compared to designs with a solid shaft. For example, bearings 213 can be located in hollow shaft 206 and support axial flux motor 217 on fixed axle 201. The rotor plates of rotors 208 and 209 can be supported by bearings 213 and may include a hollow center. Stator 207 of axial flux motor 217 can be supported by fixed axle 201. In specific embodiments, stator 207 can be attached to motor housing 202 which is supported by fixed axle 201. System 200 may also include cap 203. In specific embodiments, a gear train may be connected to axial flux motor 217. As used herein, an axial flux motor and gear train assembly can be referred to as a drive train.

As used herein, the term “rotor” may refer to a “rotor” or to a “rotor disc.” In specific embodiments where multiple “rotors” are connected to (e.g., mounted on) the same rotor shaft (e.g., hollow shaft), this may be interpreted to mean that multiple “rotor discs” are mounted on the same rotor shaft, such that these separate “rotors” are really a single rotor (e.g., form a single rotor). Similarly, the term “stator” may refer to a “stator” or to a “stator disc.” In specific embodiments where different “stators” are electrically connected, each “stator” may refer to a “stator disc” such that each of the “stators” form a single stator.

In specific embodiments, rotors 208 and 209 of axial flux motor 217 are rigidly connected to a gear train to transfer their rotational movement to the gear train. Rotor 208 may be a non-dual-stator (NDS) rotor and rotor 209 may be a dual-stator (DS) rotor. In specific embodiments, fixed axle 201 can support two or more stators or two or more rotors where the rotors can be rigidly connected to the same gear train. In specific embodiments, the gear train can be an epicyclic gear train with sun gear 210, planetary gear 211, and planetary carrier 212. Planetary carrier 212 may also be referred to as a ring gear. Planetary gear 211 may also be referred to as a planet gear. Sun gear 210 of the epicyclic gear train, situated at the center of the rotational axis of the gear train, can be designed to incorporate a central hole to accommodate the same fixed axle 201 that supports axial flux motor 217. This modification ensures the stability of system 200 while enabling the transmission of torque. Planetary carrier 212 may be adapted to connect to wheel hub 205, effectively powering wheel hub 205 while featuring a through hole for support from fixed axle 201. This approach allows for the simultaneous powering of wheel hub 205 and the provision of a through hole in both axial flux motor 217 and gearbox 218 for system support and compact integration with wheel hub 205.

System 200 may include a drive train for a wheeled vehicle. System 200 may include fixed axle 201, axial flux motor 217, and gearbox 218. Axial flux motor 217 may include set of bearings 213 supported on fixed axle 201 and hollow shaft 206 (e.g., a rotor shaft) supported by set of bearings 213. Bearings 213 may be inside hollow shaft 206 (e.g., the rotating shaft), holding and supporting hollow shaft 206 from the inside. Gearbox 218 may be supported on fixed axle 201 by set of bearings 214. Gearbox 218 may include sun gear 210 rigidly connected to a rotor (e.g., rotor 208, rotor 209, or both) of axial flux motor 217 and at least one planetary gear 211. Planetary gear 211 may be in contact with sun gear 210. An output of gearbox 218 may be rigidly connected to wheel hub 205 and planetary gear 211. In specific embodiments, sun gear 210 and planetary gear 211 are both part of a simple planetary gear system, a compound planetary gear system, or a stepped planetary gear system. In specific embodiments, wheel hub 205 surrounds at least a portion of gearbox 218 in a radial direction.

The drive train of system 200 may also include motor housing 202 rigidly connected to fixed axle 201 and supported on fixed axle 201. Motor housing 202 may encapsulate axial flux motor 217. Axial flux motor 217 may also include at least one stator 207 rigidly connected to motor housing 202 and supported by motor housing 202. Axial flux motor 217 and gearbox 218 may be adjacent on fixed axle 201. In specific embodiments, axial flux motor 217 may serve as a single motor for gearbox 218 and gearbox 218 may not be connected to (e.g., may refrain from connecting to) any other motor.

Motor housing 202, complete with fins, may be mounted on fixed axle 201 (e.g., via a through shaft), firmly immobilizing motor housing 202 in all degrees of freedom relative to the fixed axle 201. The static components of axial flux motor 217, in turn, may be linked to motor housing 202, deriving their reactions from fixed axle 201 through their connection to motor housing 202. The rotating components of axial flux motor 217 can be directly affixed to hollow shaft 206 using flanges. The suspension and a swing arm of the vehicle may be mounted to fixed axle 201. The transmission unit may incorporate a gear train system designed to accommodate fixed axle 201. The output of the planetary gear train (e.g., sun gear 210, planetary gear 211, and planetary carrier 212) may be directly linked to the wheel rim (e.g., wheel hub 205), as depicted in the diagram. Planetary carrier 212 may be supported on fixed axle 201 by a set of bearings 214 (e.g., inner-diameter bearings) and may be separated from gearbox housing 204 by a set of bearings 215 (e.g., outer-diameter bearings).

System 200 may have a securing and spacing feature secured to axle 201 that fixes one side of rotor 208 or 209 relative to a length of axle 201, a flange on the other side of axle 201 that fixes the other side of rotor 208 or rotor 209 relative to a length of the axle 201. In specific embodiments, system 200 may have one rotor, two rotors, or more. The rotors may be fixed relative to a length of fixed axle 201 such that the rotors may rotate around fixed axle 501 but do not slide along fixed axle 201. For example, a securing and spacing feature may secure the right side of rotor 209 as viewed in FIG. 2 relative to a length of fixed axle 201, and a flange on fixed axle 201 may secure the left side of rotor 208 as viewed in FIG. 2 relative to a length of fixed axle 201. In specific embodiments, stator 207 may be secured to motor housing 202 via the flange such that the positioning of rotor 208, rotor 209, and stator 207 are well controlled.

System 200 may include axial spacing ring 221 around fixed axle 201, axial spacing ring 222 around fixed axle 201, and fastener 229 around fixed axle 201 and between axial spacing ring 221 and axial spacing ring 222. System 200 may act to maintain the airgap of axial flux motor 217. System 200 is exemplary only, as there may be other ways to restrict sideways motion of rotors and stators.

In specific embodiments, bearings 220 (e.g., axial thrust bearing) may be used between sun gear 210 and axial spacing ring 221 to set the axial gaps. Bearing 220 and axial spacing ring 221 may surround fixed axle 201. In specific embodiments, axial spacing ring 222 is next to axial spacing ring 221 and fastener 229 (such as a circlip, ring, nut, screw, bolt, anchor, roll pin, etc.) may be between the two axial spacing rings 222 and 221. The assembly of axial spacing rings 222 and 221 as well as fastener 229 may act to restrict sideways motion of stator 207 and rotors 208 and 209 of axial flux motor 217 such that the relative distances between stator 207, rotor 208, rotor 209, and motor housing 202 along axle 201 do not change. Accordingly, the airgaps of axial flux motor 217 may be maintained.

By mounting fixed axle 201 on both sides of axial flux motor 217, the structural integrity of axial flux motor 217 and its components are maintained while the same fixed axle 201 also supports the wheel of the vehicle. This allows compact integration of axial flux motor 217 and gearbox 218 with wheel hub 205. In certain applications, such as when axial flux motor 217 and gearbox 218 are integrated with an electric vehicle, the compact nature of these designs exhibits significant benefits in that axial flux motor 217 is placed closer to the center of gravity of the wheel it drives. Furthermore, if the electric vehicle is a scooter or other vehicle in which the wheel is expected to tilt down towards the ground, the compact integration designs of axial flux motor 217 and gearbox 218 disclosed herein interfere less with the potential operation of the vehicle because they are so compact.

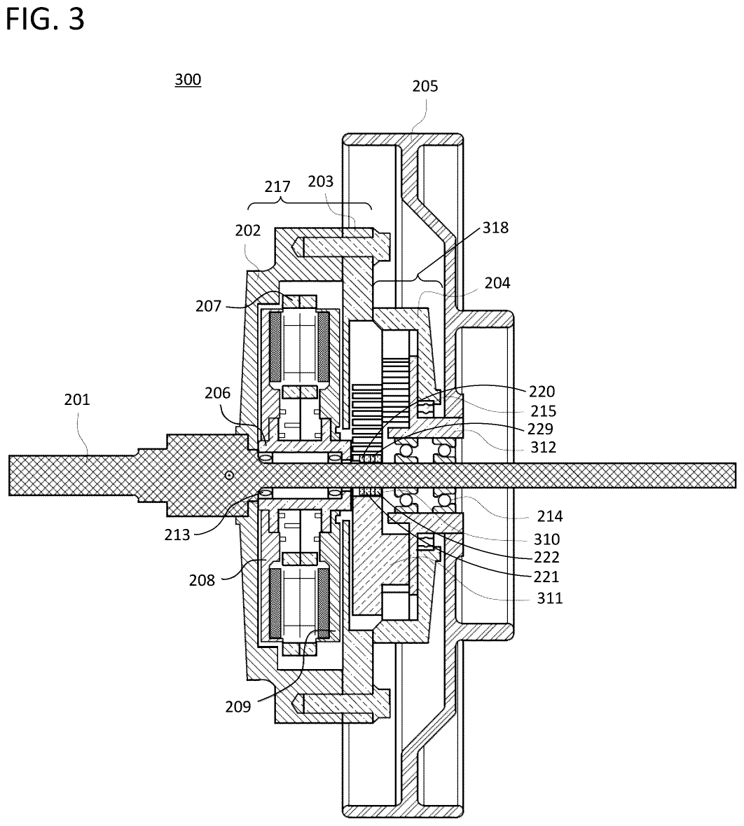

FIG. 3 illustrates a similar approach to that in FIG. 2. The bearing arrangement is similar and the manner in which the gearbox and motor are integrated with the wheel (e.g., wheel hub) is similar. System 300 of FIG. 3 differs in that the planetary gear system includes stepped planetary gear 311 which is turned by sun gear 310 and turns the planetary carrier 312 according to the difference in the radius of the step in stepped planetary gear 311.

System 300 may include a drive train for a wheeled vehicle. System 300 may include fixed axle 201, axial flux motor 217, and gearbox 318. Axial flux motor 217 may include set of bearings 213 supported on fixed axle 201 and hollow shaft 206 (e.g., a rotor shaft) supported by set of bearings 213. Gearbox 318 may be supported on fixed axle 201 by set of bearings 214. Gearbox 318 may include sun gear 310 rigidly connected to a rotor (e.g., rotor 208, rotor 209, or both) of axial flux motor 217 and at least one stepped planetary gear 311. Stepped planetary gear 311 may be in contact with sun gear 310. An output of gearbox 318 may be rigidly connected to wheel hub 205 and stepped planetary gear 311. In specific embodiments, a “rigid” connection may not be completely rigid. For example, sun gear 310 and hollow shaft 206 may be connected through a spline interface. This may allow for some small misalignment due to wheel forces acting on axle 201 that may distort axle 201 (e.g., by a few hundred micrometers), causing misalignment between some sets of bearings.

In specific embodiments, sun gear 310 and stepped planetary gear 311 are both part of a stepped planetary gear system, which may be a simple planetary gear system or a compound planetary gear system. In specific embodiments, wheel hub 205 surrounds at least a portion of gearbox 318 in a radial direction.

System 300 may include axial spacing ring 221 around fixed axle 201, axial spacing ring 222 around fixed axle 201, and fastener 229 around fixed axle 201 and between axial spacing ring 221 and axial spacing ring 222. In specific embodiments, bearings 220 may be used between sun gear 310 and axial spacing ring 221 to set the axial gaps. In specific embodiments, fastener 229 may be a circlip, ring, nut, screw, bolt, anchor, roll pin, etc. The assembly of axial spacing ring 221, fastener 229, and axial spacing ring 222 may act to restrict sideways motion of stator 207 and rotors 208 and 209 of axial flux motor 217 such that the relative distances between stator 207, rotor 208, rotor 209, and motor housing 202 along axle 201 do not change. Accordingly, the airgaps of axial flux motor 217 may be maintained.

The tight integration of axial flux motor 217 as well as gearbox 218 with wheel hub 205 in certain circumstances allows axial flux motor 217 to be utilized without interfering with the mobility of the vehicle on which system 300 is installed. While not illustrated, system 400 as discussed below may also incorporate the benefits associated with a stepped planetary gear system by incorporating stepped planetary gear 311.

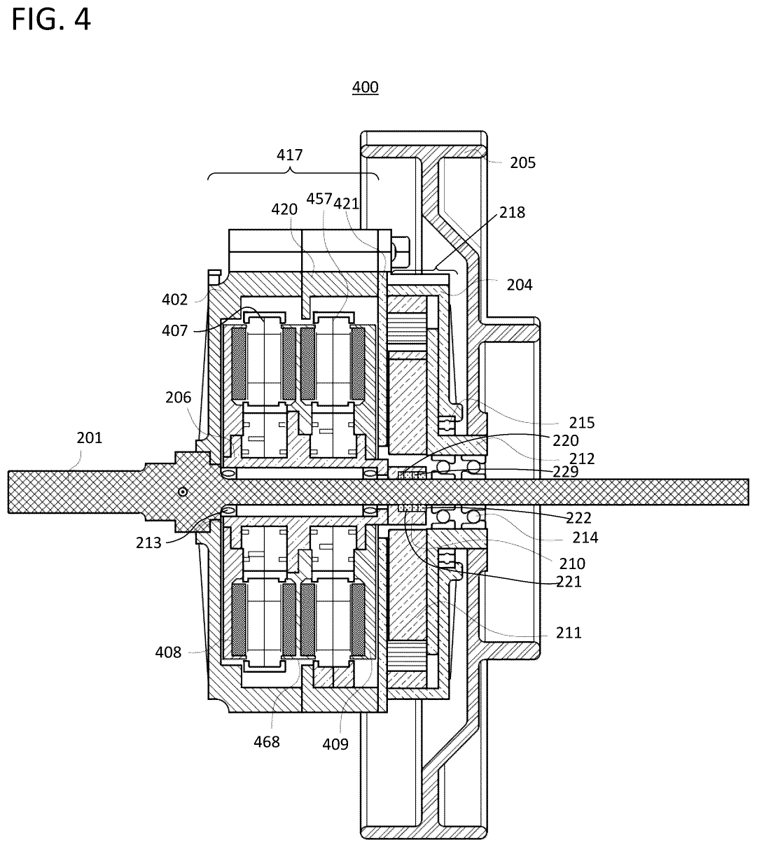

FIG. 4 is also a similar approach to that in FIG. 2 in that the bearing arrangement and integration of the motor and gearbox with the wheel is similar. FIG. 4 differs in that system 400 includes two adjacent and co-axial stators 407 and 457 with three rotors 408, 468, and 409. Stators 407 and 457 may be electrically connected to each other, such that they are part of the same circuit. As used herein, the term “rotor” may refer to a “rotor” or to a “rotor disc.” In specific embodiments where multiple “rotors” are connected to (e.g., mounted on) the same rotor shaft (e.g., hollow shaft), this may be interpreted to mean that multiple “rotor discs” are mounted on the same rotor shaft, such that these separate “rotors” are really a single rotor. Similarly, the term “stator” may refer to a “stator” or to a “stator disc.” In specific embodiments where different “stators” are electrically connected, each “stator” may refer to a “stator disc” such that each of the “stators” form a single stator.

Rotors 408, 468, and 409 are fixedly attached to sun gear 210 of the gearbox 218. Housing 402 encapsulates stator 407 and midhousing 420 encapsulates stator 457. System 400 also includes cap 421.

System 400 may include a drive train for a wheeled vehicle. System 400 may include fixed axle 201, axial flux motor 417, and gearbox 218. Axial flux motor 417 may include set of bearings 213 supported on fixed axle 201, where hollow shaft 206 (e.g., rotor shaft) may be supported by set of bearings 213. Gearbox 218 may be supported on fixed axle 201 by set of bearings 214. Gearbox 218 may include sun gear 210, rigidly connected to rotor 408, rotor 468, and/or rotor 409, and at least one planetary gear 211. Planetary gear 211 may be in contact with sun gear 210. An output of gearbox 218 may be rigidly connected to wheel hub 205 and planetary gear 211. In specific embodiments, a “rigid” connection may not be completely rigid. For example, sun gear 210 and hollow shaft 206 may be connected through a spline interface. This may allow for some small misalignment due to wheel forces acting on axle 201 that may distort axle 201 (e.g., by a few hundred micrometers), causing misalignment between some sets of bearings.

System 400 may include axial spacing ring 221 around fixed axle 201, axial spacing ring 222 around fixed axle 201, and fastener 229 around fixed axle 201 and between axial spacing ring 221 and axial spacing ring 222. In specific embodiments, bearings 220 may be used between sun gear 210 and axial spacing ring 221 to set the axial gaps. In specific embodiments, fastener 229 may be a circlip, ring, nut, screw, bolt, anchor, roll pin, etc. The assembly of axial spacing ring 221, fastener 229, and axial spacing ring 222 may act to restrict sideways motion of stator 407, stator 457 rotor 408, rotor 468, and rotor 409 of axial flux motor 417 such that the relative distances between stator 407, stator 457 rotor 408, rotor 468, rotor 409 and motor housing 402 along axle 201 do not change. Accordingly, the airgaps of axial flux motor 417 may be maintained.

The tight integration of axial flux motor 417 as well as gearbox 218 with, wheel hub 205 in certain circumstances allows axial flux motor 417 to be utilized without interfering with the mobility of the vehicle on which system 400 is installed. In specific embodiments, more than two axial flux motor and/or more than two stators may be used in a system (e.g., similar to system 400) without interfering with the mobility of the vehicle on which they are installed. System 400 may also incorporate the benefits associated with an increased quantity of rotors and stators.

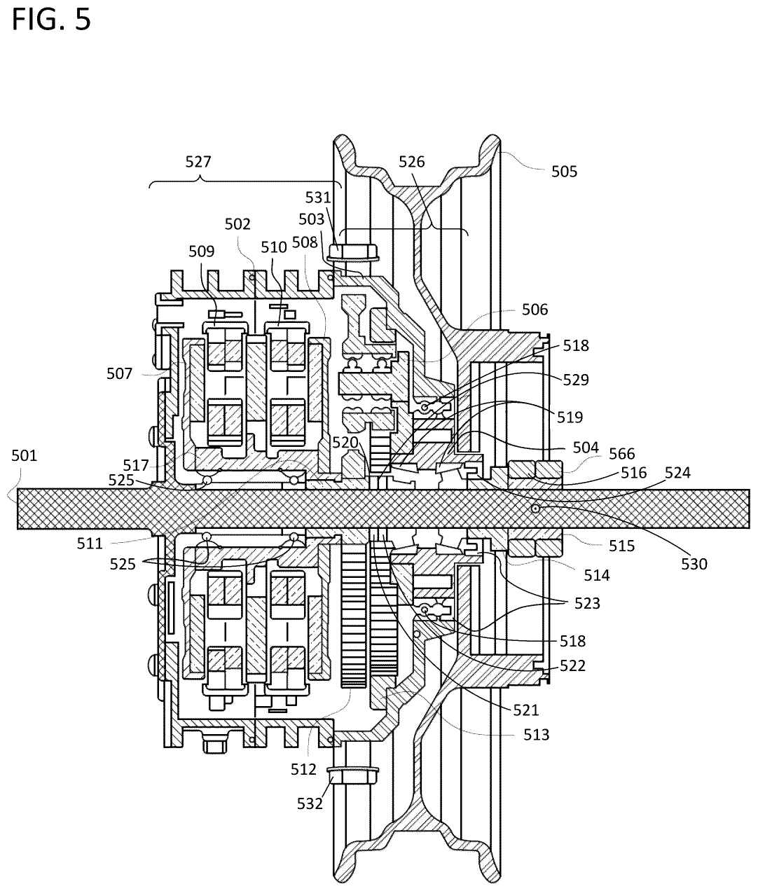

FIG. 5 illustrates system 500 with axial flux motor 527, sealing spacer 514, threaded spacing ring 515, preload nuts 516 and 566, and fixed axle 501 (e.g., a through shaft) in accordance with specific embodiments of the inventions disclosed herein. Fixed axle 501 may provide support for the stationary part of system 500. Fixed axle 501 may be mounted on both sides of axial flux motor 527 and may run through hollow shaft 517. Hollow shaft 517 may also be referred to as a rotor shaft. Axial flux motor 527 and gearbox 526 may be adjacent on fixed axle 501. Bearings 518 may be motor housing bearings, bearings 519 may be hub bearings, bearings 520 may be axial thrust bearings, and bearings 525 may be rotor bearings. FIG. 5 is exemplary only and many aspects of FIG. 5 may be modified. For example, although a drum brake is shown, a disc brake or another type of brake may be used. Similarly, the wheel attachment (e.g., wheel rim 505, wheel hub 504) connected to the output carrier (e.g., planetary carrier 506) may deviate from what is depicted. Planetary carrier 506 may also be referred to as a ring gear.

As used herein, the term “rotor” may refer to a “rotor” or to a “rotor disc.” In specific embodiments where multiple “rotors” are connected to (e.g., mounted on) the same rotor shaft (e.g., hollow shaft), this may be interpreted to mean that multiple “rotor discs” are mounted on the same rotor shaft, such that these separate “rotors” are really a single rotor. Similarly, the term “stator” may refer to a “stator” or to a “stator disc.” In specific embodiments where different “stators” are electrically connected, each “stator” may refer to a “stator disc” such that each of the “stators” form a single stator.

System 500 may include a drive train for a wheeled vehicle. System 500 may include fixed axle 501, axial flux motor 527, and gearbox 526. Axial flux motor 527 may include set of bearings 525 supported on fixed axle 501 and hollow shaft 517 (rotor shaft) supported by set of bearings 525. Gearbox 526 may be supported on fixed axle 501 by set of bearings 519. Gearbox 526 may include sun gear 511 rigidly connected to a rotor (e.g., rotor 507, rotor 508, or both) of axial flux motor 527 and at least one planetary gear 512. Planetary gear 512 may be in contact with sun gear 511. An output of gearbox 526 may be rigidly connected to wheel hub 504 and planetary gear 512. As used herein, a “rigid” connection may allow for some small misalignment. For example, misalignment may occur due to wheel forces acting on axle which may distort the axle by a small distance (e.g., a few hundred micrometers), causing misalignment between sets of bearings.

In specific embodiments, the incorporation of hollow shaft 517 into system 500 necessitates specialized internal motor and transmission components, (e.g., bearings, shafts, rotor plates, stators, and more). Bearings 525 may be at least partially enclosed by hollow shaft 517. For example, bearings 525 can be located in hollow shaft 517 and support axial flux motor 527 on fixed axle 501. The rotor plates of rotors 507 and 508 can be supported by bearings 525 and may include a hollow center. Stators 509 and 510 of axial flux motor 527 can be supported by fixed axle 501. In specific embodiments, stators 509 and 510 can be attached to motor housing 502 which is supported by fixed axle 501. In specific embodiments, a gear train may be connected to axial flux motor 527. An axial flux motor and gear train assembly may be referred to as a drive train.

In specific embodiments, the rotors 507 and 508 are rigidly connected to a gear train to transfer their rotational movement to the gear train. Rotor 507 may be an NDS rotor and rotor 508 may be a DS rotor. In specific embodiments, fixed axle 501 can support more than one axial flux motor, each with one or more rotors and one or more stators. Each rotor 507 and 508 can be rigidly connected to the same gear train. The gear train can be an epicyclic gear train (e.g., sun gear 511, one or more planetary gears 512, and planetary carrier 506). Sun gear 511, situated at the center of the rotational axis of the gear train, can be designed to incorporate a central hole to accommodate the same axle 501 that supports axial flux motor 527. This axle system ensures the stability of system 500 while enabling the transmission of torque. Planetary carrier 506, serving as the output shaft of the epicyclic gear train, may be connected to wheel hub 504, effectively powering wheel hub 504 while featuring a through hole for fixed axle 501 support. This approach allows for the simultaneous powering of wheel hub 504 and the provision of a through hole in both axial flux motor 527 and the gear train for system 500 support and compact integration with wheel hub 504. In specific embodiments, the gear teeth count on sun gear 511, planetary gear 512, planetary carrier 506, and planetary carrier 513 (e.g., ring gear) are chosen to achieve torque, efficiency, and packaging enhancements.

In specific embodiments, axial thrust bearing 520 may be used between sun gear 511 and axial spacing ring 521 to set the axial gaps. The hardness of the mating surfaces may be chosen such that the airgap variation over the lifetime of axial flux motor 527 is minimized. Axial thrust bearings 520, axial spacing rings 521 and 522, and fastener 529 (e.g., circlip, nut, ring, screw, bolt, anchor, roll pin, etc.) may wholly or partially surround fixed axle 501 to restrict sideways motion of stators 509 and 510 and rotors 507 and 508 such that the relative distances between stator 509, stator 510, rotor 507, rotor 508, and motor housing 502 along fixed axle 501 do not change. The position of motor housing 502 is maintained relative to fixed axle 501 as motor housing 502 is mounted on a flange of fixed axle 501. Accordingly, the airgaps of axial flux motor 527 may be maintained.

System 500 may have a securing and spacing feature secured to axle 501 that fixes one side of a rotor relative to a length of axle 501, a flange on the other side of axle 501 that fixes the other side of the rotor relative to a length of the axle 501, or a side of a different rotor. In specific embodiments, system 500 may have one rotor, two rotors, three rotors, or more. The rotors may be fixed relative to a length of fixed axle 501 such that the rotors may rotate around fixed axle 501 but do not slide along fixed axle 501. For example, a securing and spacing feature may secure the right side of rotor 508 as viewed in FIG. 5 relative to a length of fixed axle 501, and a flange on fixed axle 501 may secure the left side of rotor 507 as viewed in FIG. 5 relative to a length of fixed axle 501. In specific embodiments, stators 509 and 510 may be secured to motor housing 502 via the flange such that the positioning of rotor 507, rotor 508, stator 509, and stator 510 are well controlled.

In specific embodiments, a lubricant (e.g., transmission oil, grease) may be input to the drive train. The lubricant may be shared between gearbox 526 and axial flux motor 527 sections of the drive train. The pumping action of rotor 507 and/or rotor 508 of the axial flux motor 527 may result in lubricant flow that reaches many or all gears and bearings of the drive train, including high speed rotor bearings 525.

In specific embodiments, bearings 519 may be preloaded. Bearings 519 may be used to support and provide a rigid path for external loads seen by a wheel rim 505 and wheel hub 504. Two nuts 516 and 566 may be tightened on a spacing ring to transmit the preload to the bearings. Nut 516 may provide the preload to the bearings and nut 566 may prevent the loss of preload.

Bearings and surfaces that the bearings are in contact with may have hardnesses in a specific range or a specific range relative to the hardness of other components. For example, the surfaces in contact with the bearings may be at least as hard as the associated bearings. As another example, the bearings may have a hardness of 58-62 on the Rockwell Hardness C Scale (HRC) and the surfaces that the bearings are in contact with may have hardnesses also in the range of 58-62 HRC. Hardness may be a key factor in determining materials for bearings 520 (e.g., axial thrust bearings), bearings 518 (e.g., motor house bearings), bearings 519 (e.g., hub bearings), and bearings 525 (e.g., rotor bearings). Sun gear 511, roll pin 530, and threaded spacing ring 515 may have similar hardnesses (e.g., 58-63 HRC). Having the surfaces in contact with bearings being about the same hardness or harder than the bearings themselves may reduce wear on the surfaces, which in turn may maintain the airgap of axial flux motor 527.

System 500 creates numerous benefits when attached to a wheeled vehicle. By mounting fixed axle 501 on both sides of axial flux motor 527, the structural integrity of axial flux motor 527 and its components are maintained while the same fixed axle 501 also supports the wheel of the vehicle. This allows compact integration of axial flux motor 527 and gearbox 526 with wheel hub 504. The compact nature of these designs exhibits significant benefits in that axial flux motor 527 may be placed closer to the center of gravity of the wheel it drives. Furthermore, if the electric vehicle is a scooter or other vehicle in which the wheel is expected to tilt down towards the ground, the compact axial flux motor and gearbox integration designs disclosed herein interfere less with the potential operation of the vehicle because they are so compact.

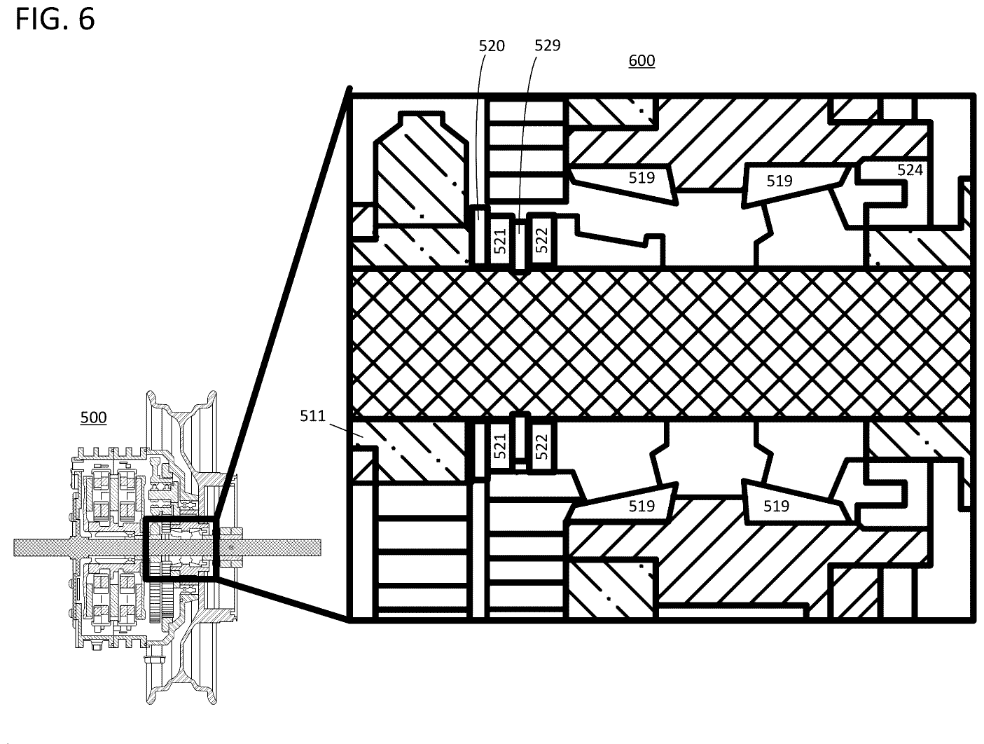

FIG. 6 depicts assembly 600, which is a portion of system 500, in accordance with specific embodiments of the inventions disclosed herein. Assembly 600 includes axial spacing ring 521 around fixed axle 501, axial spacing ring 522 around fixed axle 501, and fastener 529 around fixed axle 501 and between axial spacing ring 521 and axial spacing ring 522. Assembly 600 may act to maintain the airgap of axial flux motor 527. Assembly 600 is exemplary only, as there may be other ways to restrict sideways motion of rotors and stators.

In specific embodiments, axial thrust bearing 520 may be used between sun gear 511 and axial spacing ring 521 to set the axial gaps. Axial thrust bearing 520 and axial spacing ring 521 may surround the fixed axle 501. In specific embodiments, axial spacing ring 522 is next to axial spacing ring 521 and fastener 529 (such as a circlip, ring, nut, screw, bolt, anchor, roll pin, etc.) may be between the two axial spacing rings 522 and 521. Fastener 529 may hold the position of assembly 600. The assembly of axial spacing rings 522 and 521 as well as fastener 529 may act to restrict sideways motion of stators 509 and 510 and rotors 507 and 508 of axial flux motor 527 such that the relative distances between stator 509, stator 510, rotor 507, rotor 508, and motor housing 502 along axle 501 do not change. Accordingly, the airgaps of axial flux motor 527 may be maintained.

Portions of assembly 600 may be optional. For example, there may be other ways to make a shoulder or reference point on a smooth shaft (e.g., roll pin, circlip, ring, nut, screw, tapped screw, bolt, anchor). The smooth geometry (e.g., absence of holes, divots, or protrusions) of fixed axle 501 in assembly 600 may ease assembly or fabrication of system 500. For example, to assemble or fabricate system 500, bearings such as axial thrust bearings 520 may be mounted from the right side of FIG. 5, which may be facilitated if fixed axle 501 is smooth. All or a portion of fixed axle 501 may be smooth. Fixed axle 501 may include flanges. In specific embodiments, a portion of fixed axle 501 may be smooth between bearings 525 and the end of axle 501 (the right end, as seen in FIG. 5, the end closer to wheel hub 504). In specific embodiments, portion of fixed axle 501 may be smooth between bearings 520 and the end of axle 501. In specific embodiments, portion of fixed axle 501 may be smooth between bearings 518 and the end of axle 501. In specific embodiments, portion of fixed axle 501 may be smooth between bearings 519 and the end of axle 501. The smooth portion of fixed axle 501 may support various features of system 500 including bearings 525, bearings 520, bearings 519, and bearings 518.

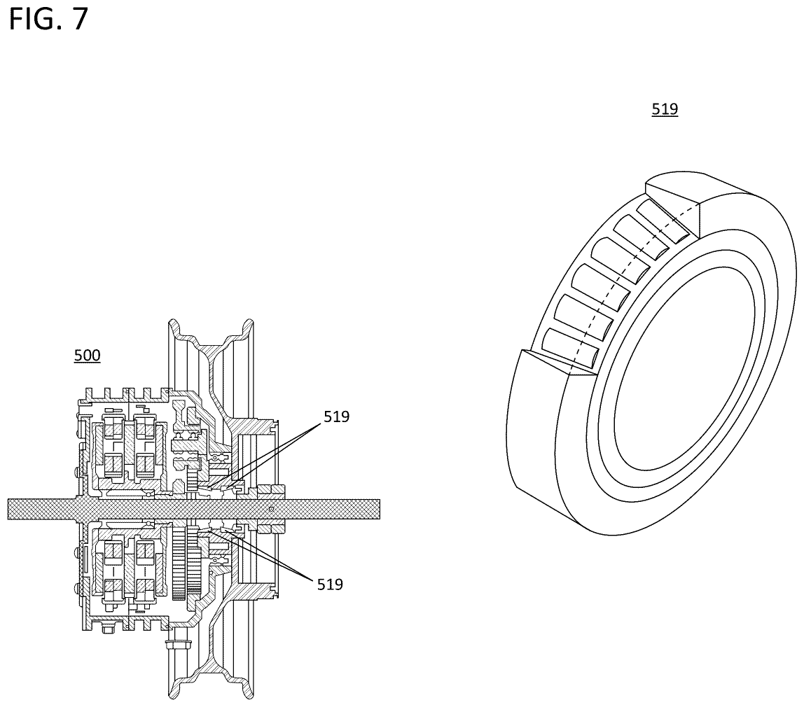

FIG. 7 depicts bearings 519 of system 500 in accordance with specific embodiments of the inventions disclosed herein. Each set of bearings 519 may be a row of tapered roller bearings. The pair of sets of bearings 519 may be arranged back to back and may be used to support and provide a rigid path for many or all external loads seen by wheel rim 505 and wheel hub 504. Although bearings 519 are depicted in FIG. 7 as a single row of tapered roller bearings in a back-to-back arrangement, multiple rows of bearings, other arrangements of bearings, and other types of bearings may be used. For example, bearings 519 may be angular contact bearings, ball bearings, etc. Bearings 519 may be similar to or different than other bearings of system 500 such as bearings 518, bearings 520, and bearings 525. Bearings 520 (e.g., axial thrust bearings) may be ball bearings or cylindrical (roller) bearings. Bearings 518 (e.g., motor housing bearings) may be ball bearings or cylindrical bearings (e.g., cylindrical, needle, tapered, etc.). Different sets of bearings of system 500 may be constructed to meet different demands or different purposes. For example, to save costs in applications where lots of axial and moment load capacity are not needed (e.g., driving a vehicle in an area with smooth roads), angular contact bearings may be used for bearings 525. As another example, in high speed regions of the system (e.g., hub bearings 519, rotor bearings 525) ball bearings may be used. In specific embodiments, a size of ball bearings used for bearings 525 may be similar to a size of ball bearings used for bearings 519 or supporting the axial load.

Wheel hub 504 may be attached to fixed axle 501 via bearings 519. Fixed axle 501 may be stationary (e.g., fixed axle 501 may be part of the vehicle chassis), while wheel hub 504 rotates or spins. Loads may transfer through the wheel to wheel rim 505 and into system 500. Loads may include shock loads (e.g., potholes, hills, etc.) and normal loads (e.g., vehicle turning). To prevent damage to the gear train, (e.g., gears crashing into each other), bearings 519 are preloaded to support these loads. That is, to ensure that bearings 519 adequately support these loads, a rigid path for the loads from wheel rim 505 to bearings 519 is established.

Bearings 519 and other components of system 500 may mitigate or eliminate load forces going through the gears of system 500. By providing a rigid path for the load forces to travel, these features protect the gears. Gears may be critical for the operation of system 500 and may be expensive to repair. Misalignment or damage to gears may result in loud noises and durability issues. To adequately protect the gears and other components of system 500, bearings 519 may be fixed in place. If bearings 519 are too loose (e.g., installed without preload or with too little preload), then a load (e.g., in a certain direction) may move axle 501, damaging components of system 500. Bearings 519 may be able to separate out. Each individual bearing may be limited to carrying the load in one direction. That is, one bearing in the set of bearings 519 may be able to resist moving (e.g., absorb load) in one direction while another bearing in the set of bearings 519 may be able to resist moving in another direction. If bearings 519 are adequately preloaded or locked in place, then bearings 519 may transmit load to a structure such as fixed axle 501. As axle 501 acts as a fixed support, it may handle the load better than other portions of system 500. To increase transfer of load (e.g., axial load) through bearing 519 to fixed axle 501, bearings 519 may be supported (e.g., on both axial sides) by nuts 516 and 566. Nuts 516 and 566 may be any type of fastener (e.g., circlip, ring, screw, bolt, anchor, roll pin, etc.).

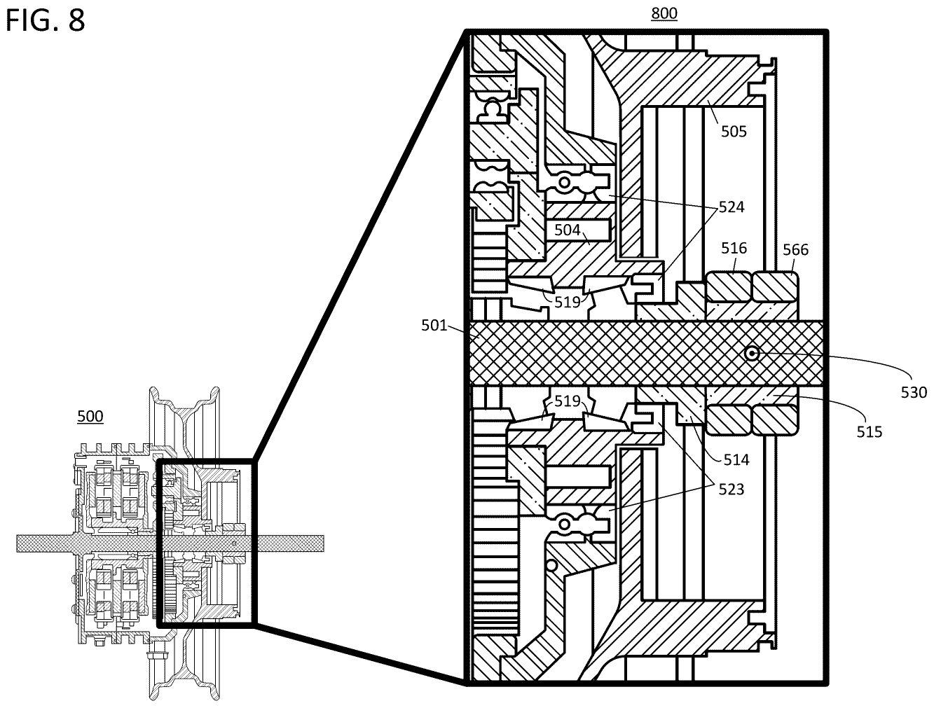

FIG. 8 depicts assembly 800 of system 500 featuring preload components in accordance with specific embodiments of the inventions disclosed herein. Assembly 800 includes fixed axle 501, wheel hub 504, bearings 519, threaded spacing ring 515, preload nut 516, and preload nut 566. Although depicted as nuts, nuts 516 and 566 may be any type of fastener (e.g., circlip, ring, screw, bolt, anchor, roll pin, etc.).

In specific embodiments, bearings 519 may be preloaded. Bearings 519 may be used to support and provide a rigid path for external loads seen by a wheel rim 505 and wheel hub 504. Two nuts 516 and 566 may be tightened on threaded spacing ring 515 to transmit the preload to the bearings. Nut 516 may be located around fixed axle 501 and to the side of the gearbox 526 that is away from the axial flux motor 527 (right side in FIG. 8). Nut 516 may be installed (e.g., tightened) with a first torque, preloading bearings 519. Nut 566 may be located around fixed axle 501 and to the side of nut 516. Nut 566 may be on the side of nut 516 that is away from gearbox 526 (right side in FIG. 8). Nut 566 may be installed (e.g., tightened) with a second torque. The second torque of nut 566 may be higher than the first torque of nut 516. For example, the first torque may be around 3 Newton-meters while the second torque may be around 40 Newton-meters. Nut 566 may prevent the loss of preload over time (e.g., due to vibrations and shock), for example by restricting the movement of nut 516. Nut 566 may refrain from loading bearings 519 and may be threaded. In specific embodiments, the torques used to install nuts 516 and 566 may be calculated and analyzed with software to optimize the operational preload for bearings 519. Nut 516 may be installed within a small range of torque (e.g., installed more precision and control) while nut 566 may be installed within a large range of torque (e.g., installed with less precision).

Other components of system 500 may assist in preloading bearings 519. Roll pin 530 may keep axle 501 fixed and may fix threaded spacing ring 515 onto axle 501. Threaded spacing ring 515 may be fixed to axle 501 in a variety of ways, such that roll pin 530 is optional. For example, system 500 may use one or more press fits, snap rings, nuts, adhesives, screws, tapped screws, etc. or a combination thereof. Roll pin 530 may not be able to take high loads, so nut 516 may be used to preload bearings 519 instead. Threaded spacing ring 515 may be a flange with a thread along a cylindrical face. Spacer 514 may act as a surface for the seal to run and may be in contact with (e.g., touch) bearings 519 (e.g., on the right side). As nut 516 is tightened, it may touch spacer 514, which may be contact with bearings 519. Accordingly, preloading nut 516 may preload bearings 519.

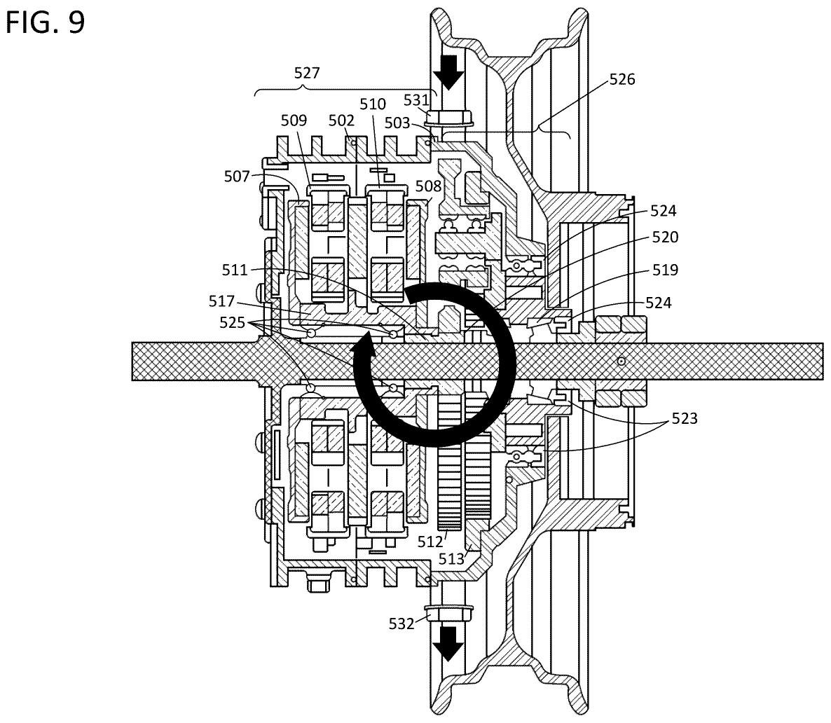

FIG. 9 depicts lubrication of system 500 in accordance with specific embodiments of the inventions disclosed herein. To achieve high topological efficiency and enhanced motor cooling, lubricant may be shared between gearbox 526 and axial flux motor 527 sections. Rotor 507, rotor 508, or both may circulate a lubricant (e.g., transmission oil, grease) within axial flux motor 527, within gearbox 526 (e.g., into gearbox cover 503), around bearings 525, around bearings 519, and around bearings 520. In specific embodiments, a separator plate between rotor 508 and gearbox 526 may alter the circulation of the lubricant. The speed difference between rotors 507 and 508 and gearbox 526 as well as the geometry of rotors 507 and 508 may cause axial flux motor 527 to act as a pump, flowing lubricant throughout system 500. Lubricant may be put into system 500 at fill port 531 and may be drained at drain port 532.

In specific embodiments, a lubricant (e.g., transmission oil) may be input to the drive train. The lubricant may be shared between gearbox 526 and axial flux motor 527 sections of the drive train. The pumping action of rotor 507 and/or rotor 508 of the axial flux motor 527 may result in lubricant flow that reaches many or all gears and bearings of the drive train. The gap between sun gear 511 and hollow shaft 517 may provide passage for the lubricant to reach bearings 525 (e.g., high speed rotor bearings). In specific embodiments, a separator plate between the motor housing 502 and gearbox cover 503 may regulate the flow of lubricant.

Lubricant may circulate through the cavities of axial flux motor 527 and gearbox 526. Seals 523 and 524 prevent the lubricant from escaping the right side of gearbox 526. Seals 523 and 524 may be rotating seals. An O-ring on a flange of fixed axle 501 prevents the lubricant from escaping from the left side of axial flux motor 527. Rotors 507 and 508 may pump lubricant around the cavities. Rotors 507 and 508 may act as pumps because they run at high speed compared to gearbox 526, and the resulting pressure differential between the motor cavity and gearbox cavity may circulate the lubricant. In specific embodiments, lubricant may reach bearings 525 located inside hollow shaft 517, bearings 520, bearings 519, sun gear 511, planetary gear 512, planetary carrier 513, stator 509, and stator 510.

The rotation of rotors 507 and 508 may allow lubricant to reach bearings 525. Bearings 525 may be located at least partially inside hollow shaft 517, near the center of rotation of system 500, and may be almost hidden away (e.g., buried inside hollow shaft 517 at a sharp right angle). A spline may connect sun gear 511 and hollow shaft 517 such that there is a gap between the two components. When lubricant (e.g., transmission oil) flows around the cavities of system 500, it may be able to flow through the spline and into the space of bearings 525. The circulation of lubricant caused by rotors 507 and 508 may allow system 500 to use transmission oil, rather than grease or other lubricants that wear away.

In specific embodiments, a separator plate may be inserted into system 500. For example, the separator plate may be a thin plate between the two cavities of axial flux motor 527 and gearbox 526 (e.g., gearbox cover 503). The separator plate may regulate the flow and/or trajectory of the lubricant. The separator plate may include features to channel the flow of the lubricant from rotors 507 and 508. Various geometries of the separator plate are possible, some geometries may cause more flow or less flow. In specific embodiments, system 500 may include forced lubrication. For example, transmission oil may be injected into very specific portions of system 500 and a separator plate may further control oil flow.

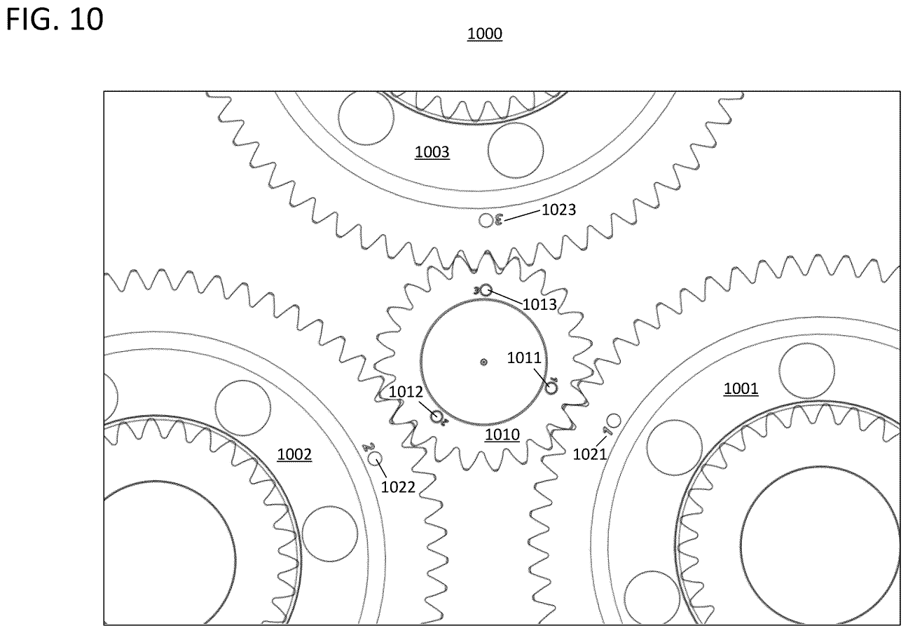

FIG. 10 depicts an example of planetary system 1000 with sun gear 1010 and planetary gears 1001, 1002, and 1003 in accordance with specific embodiments of the inventions disclosed herein. Planetary system 1000 may also include a planetary carrier (e.g., ring gear) that is not shown. Each component of planetary system 1000 may have a prime number of gear teeth. Planetary system 1000 may be part of system 200 or system 500.

In specific embodiments, the gear teeth count on sun gear 1010, planetary gears 1001, 1002, and 1003, and the ring gear may be chosen to achieve torque, efficiency, and packaging enhancements. The gear teeth count on sun gear 1010, planetary gears 1001, 1002, and 1003, and the ring gear may each be prime numbers. Gear teeth counts may be determined via software and may be based on the specified application of planetary system 1000.

Planetary system 1000 may include markings on sun gear 1010 and a marking on each of planetary gears 1001, 1002, and 1003. The markings may assist in assembly. For example, during assembly, marking 1011 of sun gear 1010 may be aligned with marking 1021 of planetary gear 1001, marking 1012 of sun gear 1010 may be aligned with marking 1022 of planetary gear 1002, and marking 1013 of sun gear 1010 may be aligned with marking 1023 of planetary gear 1003. The markings and alignment of markings may be especially useful when the gears have prime numbers of teeth, as the gears may not be evenly spaced and the angles between each planetary gear 1001, 1002, and 1003 and sun gear 1010 may be distinct. Gear markings may also be referred to as timing marks, and when the markings are aligned, the gear system may be clocked. The clocking system may be unique to planetary system 1000, the specific gears used, and the teeth counts of those gears.

When using gears with a prime number of teeth, planetary system 1000 may experience various advantages, for example noise, vibration, and harshness (NVH) advantages as well as prolonged life. If one gear tooth is deformed, then the impacts of the deformation on companion gears may be spread throughout the companion gears, rather than the deformed gear tooth excessively hitting the same gear groove (or few grooves) of the companion gears. Gear systems such as planetary system 1000 may also be less prone to excite frequencies and resonance.

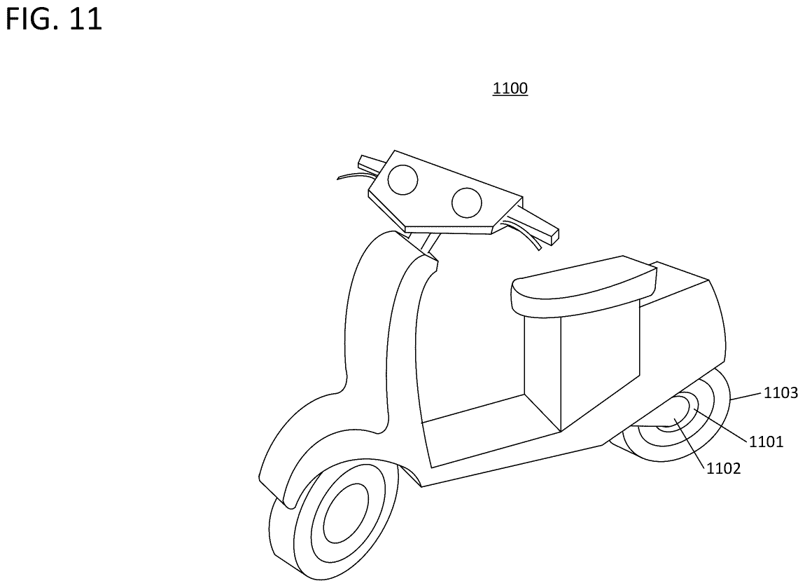

FIG. 11 depicts wheeled vehicle 1100 (e.g., an electric scooter) having a drive drain in accordance with specific embodiments of the inventions disclosed herein. The drive train may include at least one wheel hub 1101 (e.g., for a tire of the electric scooter), a fixed axle, an axial flux electric motor, and a gearbox. The axial flux electric motor may include a first set of bearings supported on the fixed axle and a rotor shaft supported by the first set of bearings. The gearbox may be supported on the fixed axle by a second set of bearings and may include a sun gear rigidly connected to a rotor of the axial flux electric motor and at least one planetary gear in contact with the sun gear. An output of the gearbox may be rigidly connected to the at least one wheel hub 1101 and the at least one planetary gear. In specific embodiments, the fixed axle is supported by swing arm 1102 of the electric scooter.

The axial flux electric machines and associated gear trains may compactly integrate with an electric mobility vehicle such as wheeled vehicle 1100 or power machinery. In specific embodiments, the axial flux electric machines and associated gear trains may be supported by a through rod or axle such as an axle supporting wheel 1103 (or additional wheels) of wheeled vehicle 1100 (e.g., an electric scooter).

In specific embodiments, the axial flux electric machines and gear trains disclosed herein can be compactly integrated. For example, the axial flux electric machines and gear trains can be adjacent to each other on an axle that supports the axial flux electric machine and gear trains. The axle can be the axle of wheel 1103 that is driven by the axial flux electric machine and the gear train. The gear train can be at least partially surrounded by the wheel hub 1101. The compact nature of these designs exhibit significant benefits in that the axial flux electric machine is placed closer to the center of gravity of wheel 1103 (which it drives). Furthermore, wheel 1103 of wheeled vehicle 1100 may be expected to tilt down towards the ground (e.g., during turns). The compact axial electric machines and gear train integration designs disclosed herein interfere less with the potential operation (e.g., turning) of wheeled vehicle 1100 because they are so compact.

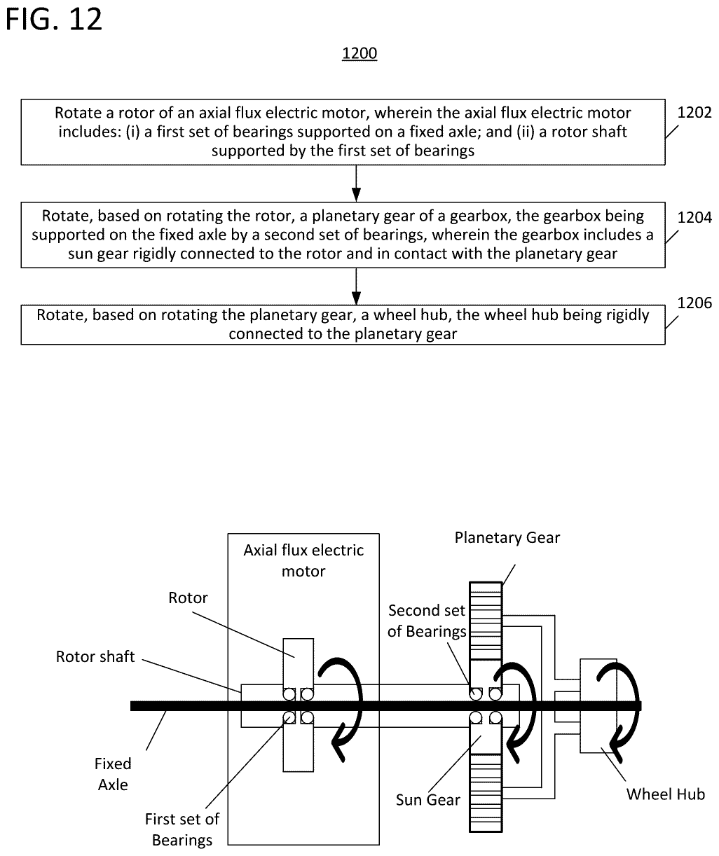

FIG. 12 depicts an example of method 1200 for operating a compact axial flux electric motor and gearbox (e.g., a drive train) in accordance with specific embodiments of the inventions disclosed herein. Method 1200 may be performed by a system including a fixed axle, an axial flux electric motor, and a gearbox. In specific embodiments, method 1200 may be performed by a system further including a motor housing, at least one stator, a wheel hub, a sun gear, at least one planetary gear, a second axial flux electric motor, at least one set of bearings, a rotor shaft, a first axial spacing ring, a second axial spacing ring, at least one fastener, lubricant, a separator plate, markings on the gears, a wheeled vehicle, or a combination thereof. In specific embodiments, method 1200 may be implemented by a system including means for performing the steps of method 1200. Steps or portions of steps of method 1200 may be duplicated, omitted, rearranged, or otherwise deviate from the form shown.

At step 1202, a rotor of an axial flux electric motor may be rotated. The axial flux electric motor may include a first set of bearings supported on a fixed axle and a rotor shaft supported by the first set of bearings. In specific embodiments, the first set of bearings may be at least partially enclosed by the rotor shaft. In specific embodiments, a motor housing may be rigidly connected to the fixed axle and supported on the fixed axle. The motor housing may encapsulate the axial flux electric motor. In specific embodiments, at least one stator may be rigidly connected to the motor housing and supported by the motor housing. In specific embodiments, a rotor of a second axial flux electric motor may be rigidly connected to the sun gear.

In specific embodiments, a first axial spacing ring may be located around the fixed axle, a second axial spacing ring may be located around the fixed axle, and a fastener may be located between the first axial spacing ring and the second axial spacing ring. In specific embodiments, the rotor of the axial flux electric motor may circulate a lubricant within the axial flux electric motor, within the gearbox, around the first set of bearings, and around the second set of bearings. In specific embodiments, a separator plate may be located between the rotor and the gearbox such that a circulation of the lubricant may be based on the separator plate.

In specific embodiments, a fastener may be located around the fixed axle and to a side of the gearbox, where the side of the gearbox is in a direction away from the axial flux electric motor. In specific embodiments, a second fastener may be located around the fixed axle and may be located to the side of (e.g., next to) the fastener, where the side of the fastener is away from the gearbox. A first torque may be applied to the fastener during installation of the fastener, a second torque may be applied to the second fastener during installation of the second fastener, and the second torque may be higher than the first torque.

At step 1204, a planetary gear of a gearbox may be rotated based on the rotating of the rotor (e.g., at step 1202). The gearbox may be supported on the fixed axle by a second set of bearings. The gearbox may include a sun gear rigidly connected to the rotor and in contact with the planetary gear. In specific embodiments, the wheel hub may surround at least a portion of the gearbox in a radial direction. In specific embodiments, the planetary gear may be a stepped planetary gear. In specific embodiments, the sun gear and planetary gear may be both part of one of: a simple planetary, compound planetary, and stepped planetary gear system. In specific embodiments, the axial flux electric motor and the gearbox may be adjacent on the fixed axle. In specific embodiments, the sun gear may have a prime number of teeth and a marking, and the at least one planetary gear may have a prime number of teeth and a marking. The marking on the sun gear and the marking on the at least one planetary gear may be aligned during assembly.

At step 1206, a wheel hub may be rotated based on the rotating of the planetary gear (e.g., at step 1204). The wheel hub may be rigidly connected to the planetary gear. In specific embodiments, the wheel hub is connected to a wheel. In specific embodiments, the axial flux electric motor serves as a single motor for the gearbox and the gearbox is not connected to any other motor. Due to its compactness, the axial flux machine and gearbox may be placed close to the center of gravity of the wheel they drive and may allow for better turning of an associated wheeled vehicle.

A portion of the fixed axle may be smooth. The portion of the fixed axle may run from the second set of bearings to an end of the fixed axle, where the end of the fixed axle may be closer to the wheel hub than the other end of the fixed axle. As used herein, a “rigid” connection may allow for some small misalignment. As used herein, the term “rotor” may refer to a rotor or to a rotor disc. In specific embodiments, where multiple “rotors” are connected to (e.g., mounted on) the same rotor shaft (e.g., hollow shaft), this may be interpreted to mean that multiple “rotor discs” are mounted on the same rotor shaft, such that these separate “rotors” form a single rotor. Similarly, the term “stator” may refer to a “stator” or to a “stator disc.” In specific embodiments where different “stators” are electrically connected, each “stator” may refer to a “stator disc” such that each of the “stators” form a single stator.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, while the detailed disclosure was generally directed to electric motors, the concepts disclosed herein are more broadly applicable to axial electric machines generally such as electric generators that are incorporated into spinning turbines. These and other modifications and variations to the present invention may be practiced by those skilled in the art, without departing from the scope of the present invention, which is more particularly set forth in the appended claims.

What is claimed is:

1. A drive train for a wheeled vehicle comprising:
a fixed axle;
an axial flux electric motor, wherein the axial flux electric motor includes: (i) a first set of bearings supported on the fixed axle; and (ii) a rotor shaft supported by the first set of bearings; and
a gearbox supported on the fixed axle by a second set of bearings, wherein the gearbox includes: (i) a sun gear rigidly connected to a rotor of the axial flux electric motor; and (ii) at least one planetary gear in contact with the sun gear;
wherein an output of the gearbox is rigidly connected to a wheel hub and the at least one planetary gear.

2. The drive train of claim 1, further comprising:
a motor housing rigidly connected to the fixed axle and supported on the fixed axle;
wherein the motor housing encapsulates the axial flux electric motor.

3. The drive train of claim 2, wherein the axial flux electric motor further comprises:
a stator including at least one stator disc rigidly connected to the motor housing and supported by the motor housing.

4. The drive train of claim 1, wherein:
the axial flux electric motor and the gearbox are adjacent on the fixed axle.

5. The drive train of claim 1, wherein:
the wheel hub surrounds at least a portion of the gearbox in a radial direction.

6. The drive train of claim 1, wherein:
the sun gear and planetary gear are both part of one of: a simple planetary, compound planetary, and stepped planetary gear system.

7. The drive train of claim 1, wherein:
the axial flux electric motor serves as a single motor for the gearbox and the gearbox is not connected to any other motor.

8. The drive train of claim 1, further comprising:
a rotor disc that forms part of the rotor; and
a second rotor disc that forms part of the rotor;
wherein the sun gear is rigidly connected to the rotor disc and the second rotor disc.

9. The drive train of claim 1, further comprising:
the planetary gear is a stepped planetary gear.

10. The drive train of claim 1, wherein:
the first set of bearings are at least partially enclosed by the rotor shaft.

11. The drive train of claim 1, further comprising:
a first axial spacing ring around the fixed axle;
a second axial spacing ring around the fixed axle; and
a fastener located between the first axial spacing ring and the second axial spacing ring.

12. The drive train of claim 1, wherein:
the rotor of the axial flux electric motor circulates a lubricant within the axial flux electric motor, within the gearbox, around the first set of bearings, and around the second set of bearings.

13. The drive train of claim 12, further comprising:
a separator plate located between the rotor and the gearbox wherein a circulation of the lubricant is based at least in part on the separator plate.

14. The drive train of claim 1, further comprising:
a marking on the sun gear, the sun gear having a prime number of teeth; and
a marking on the at least one planetary gear, the at least one planetary gear having a prime number of teeth, wherein the marking on the sun gear and the marking on the at least one planetary gear are aligned during assembly.

15. The drive train of claim 1, further comprising:
a fastener located around the fixed axle and to a side of the gearbox, the side of the gearbox being in a direction away from the axial flux electric motor.

16. The drive train of claim 15, further comprising:
a second fastener located around the fixed axle and located to a side of the fastener, the side of the fastener being away from the gearbox;
wherein a first torque is applied to the fastener during installation of the fastener, a second torque is applied to the second fastener during installation of the second fastener, and the second torque is higher than the first torque.

17. The drive train of claim 15, wherein:
a portion of the fixed axle is smooth, the portion of the fixed axle running from the second set of bearings to an end of the fixed axle, the end of the fixed axle being closer to the wheel hub than a other end of the fixed axle.

18. A wheeled vehicle comprising:
at least one wheel hub;
a fixed axle;
an axial flux electric motor, wherein the axial flux electric motor includes: (i) a first set of bearings supported on the fixed axle; and (ii) a rotor shaft supported by the first set of bearings; and
a gearbox supported on the fixed axle by a second set of bearings, wherein the gearbox includes: (i) a sun gear rigidly connected to a rotor of the axial flux electric motor; and (ii) at least one planetary gear in contact with the sun gear;
wherein an output of the gearbox is rigidly connected to the at least one wheel hub and the at least one planetary gear.

19. The wheeled vehicle of claim 18, wherein:
the wheeled vehicle is an electric scooter;
the at least one wheel hub is a wheel hub for a tire of the electric scooter; and
the fixed axle is supported by a swing arm of the electric scooter.

20. A method, comprising:
rotating a rotor of an axial flux electric motor, wherein the axial flux electric motor includes: (i) a first set of bearings supported on a fixed axle; and (ii) a rotor shaft supported by the first set of bearings;
rotating, based on rotating the rotor, a planetary gear of a gearbox, the gearbox being supported on the fixed axle by a second set of bearings, wherein the gearbox includes a sun gear rigidly connected to the rotor and in contact with the planetary gear; and
rotating, based on rotating the planetary gear, a wheel hub, the wheel hub being rigidly connected to the planetary gear.
